(19) United States
(12) Patent Application Publication
(10) Pub. No.: US 2023/0376181 A1
(43) Pub. Date: Nov. 23, 2023

(54) DISPLAY SCREEN HAVING A GRAPHIC USER INTERFACE FOR PRESENTING QUESTIONS AND ANSWERS

(71) Applicant: Ibble, Inc., Austin, TX (US)

(72) Inventors: Raymond J. Kaminski, Austin, TX (US); Eric J. Albee, Austin, TX (US)

(21) Appl. No.: 18/247,351

(22) PCT Filed: Sep. 30, 2020
(86) PCT No.: PCT/US20/53489

§ 371 Date: Mar. 30, 2023

(51) Int. Cl. G06F 3/0484; G06F 3/0488

(52) U.S. Cl. CPC G06F 3/0484; G06F 3/0488; G06F 2203/04803; G06F 40/279

(57) ABSTRACT

A platform configured to assist in the generation, organization, and distribution of user generated content. The platform may be configured to organize user generated video and/or audio content items into conversations that may be consumed by users of the platform as a group. The platform may also be configured to allow the user to quickly navigate between groups of user generated content items and individual content items with a group.

### CROSS-REFERENCE TO RELATED APPLICATION(S)

This application is a U.S. national stage application under 35 USC § 371 of International Application No. PCT/US20/53489 filed on Sep. 30, 2020 and entitled “SYSTEM AND PLATFORM FOR PUBLISHING ORGANIZED USER GENERATED VIDEO CONTENT,” the entire contents of which are incorporated herein by reference.

### BACKGROUND

Today, many industries, companies, and individuals rely upon user generated content as a source of news and information. One of the fastest growing forms of user generated content is user recorded videos. Unfortunately, many users publish related content as a series of unconnected short videos. This is a particular problem when multiple users are recording related video content and publishing via each individual user's page or thread.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example architecture of a platform for managing user generated video content according to some implementations.

FIG. 2 illustrates an example pictorial view of a user consuming a conversation via the platform of FIG. 1 according to some implementations.

FIG. 3 illustrates an example pictorial view of a user exploring source content for a conversations via the platform of FIG. 1 according to some implementations.

FIG. 4 illustrates an example pictorial view of a user viewing an active conversation list via the platform of FIG. 1 according to some implementations.

FIG. 5 illustrates an example pictorial view of a user viewing current activity associated with the user's conversation via the platform of FIG. 1 according to some implementations.

FIG. 6 illustrates an example pictorial view of a user viewing a list of conversations sparked from the user's own or participating conversations via the platform of FIG. 1 according to some implementations.

FIG. 7 illustrates an example pictorial view of an initiating user generated content item for a conversations associated with the platform of FIG. 1 according to some implementations.

FIG. 8 illustrates an example pictorial view of a user viewing their user generated content associated with the platform of FIG. 1 according to some implementations.

FIG. 9 illustrates an example pictorial view of a user recording user generated content of a conversation associated with the platform of FIG. 1 according to some implementations.

FIG. 10 illustrates an example pictorial view of a user transitioning between content items and conversations of the platform of FIG. 1 according to some implementations.

FIG. 11 illustrates an example flow diagram showing an illustrative process for organizing a conversation according to some implementations.

FIG. 12 illustrates an example flow diagram showing an illustrative process for navigating between user generated content items and conversations according to some implementations.

FIG. 13 illustrates an example flow diagram showing an illustrative process for monitoring audio content of a user generated content item according to some implementations.

FIG. 14 illustrates an example flow diagram showing an illustrative process for monitoring visual content of a user generated content item according to some implementations.

FIG. 15 illustrates an example platform for organizing user generated content items according to some implementations.

### DETAILED DESCRIPTION

Described herein is a platform configured to assist in the generation, organization, and distribution of user generated content. In particular, the platform may be configured to assist with the publication, organization, and dissemination of user generated video content, audio content, or a combination of thereof. For example, in conventional social networking platforms users typically publish video content, audio content, or a combination of thereof to a personal space within the platform, such as a feed, page, story, and the like. However, when multiple individuals are each sharing or creating related content, such as a recorded conversation between individuals, a third-party viewing or consuming the content may have difficulty in finding, ordering, and understanding the content flow.

The platform, discussed herein, is configured to organize user generated video content, audio content, or a combination of thereof in a manner representative of the conversation. For example, each individual content item that is part of a conversation may be stored, shared, and processed as a group. In some cases, the group or conversation may include a link to a news article or other source of background information to assist a third-party viewer consuming the user generated content in understanding the content or come up to speed on the topic being discussed.

In some cases, each user generated content item may be arranged in chronological order such that a consuming user may transition between content items in the order in which the content items were recorded. In some cases, the conversation may be arranged such that a consuming user may view a current user generated content item and the other user generated content items associated with the conversation may be arranged as thumbnails or icons on a display above the current user generated content item being consumed. In these cases, the thumbnail may include an image or indication of the source of the content item (e.g., a picture of the user that recorded the content may be displayed).

A consuming user may then transition back and forth between the content items by selecting the next video or audio content item to the right or a prior content item to the left. The user may also transition by swiping or sliding the screen to the right (to consume the next content item) and/or to the left (to consume the prior content item). Each user generated content item of the conversation may also include a text based summary or comment provided by the author. In some cases, the text-based summary may be displayed in conjunction with the background information, such that a consuming user is able to quickly consume the content of a specific without watching the entire length of the content item. In this manner, the consuming user may skip one or more user generated content items of a conversation without getting lost or confused when consuming subsequent content items.

In addition to transition between content items (e.g., the right and left motion), a consuming user may also explore or transition between conversations by swiping the display up (e.g., to transition to the next conversation) or down (e.g., to transition to the previous conversation). In this manner, the consuming user may both move through the related user generated content items of a single conversation and through related conversations without returning back to a menu or list.

In some cases, the users or authors allowed or authorized to publish user generated content items to a conversation may be restricted. For example, the originating or initial user that records the first content item associated with a conversation may be able to select or otherwise authorize other users to participate, post, or otherwise add additional user generated content items to the conversation. In some cases, the invited users may also invite other additional users, while in other cases, only the originating user may invite users to participate in the conversation. In other cases, a conversation may be open to the public to comment and/or add user generated content items.

In some implementations, the platform may be configured to recommend individual users for the originating user to invite. For instance, the platform may select influencers, experts, or other users that frequently comment on topics related to the background information for the originating user to invite. In other cases, the platform may recommend similar users to the originating user and/or contacts or frequently invited users for participation in the current conversations. In one particular example, the platform may suggest users that are contacts of the invited users to be invited based on their contributions to related conversations.

In some cases, even though the users that may participate in the conversation may be limited, the conversation may be available to be viewed or consumed by the general public. In these cases, a third-party user that is not participating in the conversation may desire to comment or otherwise contribute to the conversation. In these cases, the third-party user may create a supplemental conversation or sparked conversation. The sparked conversation may designate the original conversation as the background information in lieu of or in addition to a news article. In some cases, the background information may be the particular user generated content item while in other cases, the background information may be the entire conversation. In this manner, a user consuming a conversation may still provide commentary without interrupting or disturbing the conversation for the participants or other consuming users. In some case, the users participating in a conversation may also be added or invited to participate in sparked conversations.

In some cases, as a consuming user swipes along the display in an upward or downward direction, the sparked conversation may be displayed prior to other related conversations (e.g., other conversations on a similar topic or having similar background information). In some implementations, in addition to including sparked conversation, consuming users may also generate comments (such as text-based content or still image-based content) and/or share the conversations. In these implementations, the conversation may maintain metrics associated with the number of sparked conversations, comments, likes, and/or shares. These metrics may be displayed and/or accessible (e.g., linked) to the consuming user via user selected icons or buttons displayed in conjunction to the user generated content item being consumed.

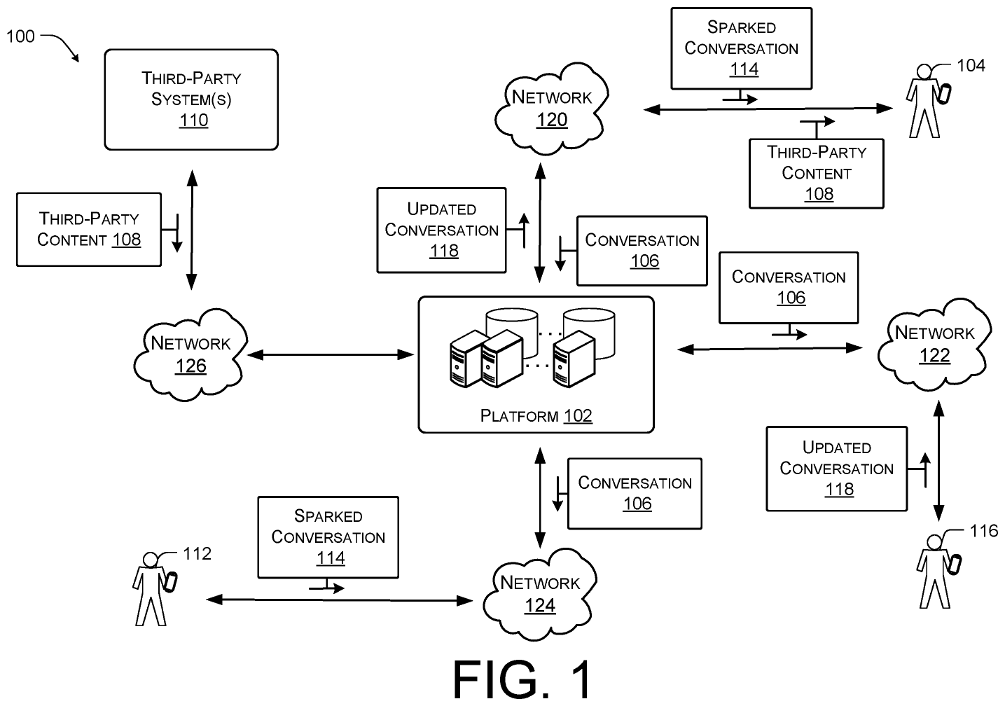

FIG. 1 illustrates an example architecture 100 of a platform 102 for managing user generated content according to some implementations. In the current example, the platform 102 may be configured to organize user generated content into conversations that may be consumed as distinct organized units. As discussed above, the conversations may include multiple related user generated content items. In some cases, the conversations may include user generated content from multiple users, such as if the multiple users were engaged in a public forum or discussion.

In the illustrated example, a user 104 may be the initiating user for a conversation 106. For example, the user 104 may initiate a conversation by generating content associated with a subject or topic. In some cases, the conversation 106 may be associated with a topic or subject. For instance, the user 104 may access third-party content 108, such as a news article, scholarly work, commentary, and the like. In some cases, the user 104 may access the third-party content 108 from a third-party system 110 via the platform 102. The user 104 may then initiate the conversation 106 by recording or otherwise capturing content associated with the third-party content. In some cases, the third-party content 108 may be linked, referenced, or otherwise accessible via the conversation 106, such that a consuming user may view or access the third-party content 108 as background information to the conversation 106.

Once the conversation 106 is initiated, the content of the conversation 106 (e.g., the content generated by user 104) may be available for viewing via the platform 102. For example, a user 112 may access the conversation 106 and/or the platform 102 may recommend the conversation 106 to the user 112 based on, for instance, prior consuming habits of the user 112, stored user data associated with the user 112, preferences of the user 112, and the like. In the illustrated example, the user 112 may be able to view and/or consume the conversation 106 via the platform 102 but be prevented or restricted from adding or contributing to the conversation 106. In this example, the user 112 may also desire to provide commentary or input as to the conversation 106. Thus, the user 112 may initiate a sparked conversation 114 (e.g., a new conversation that is in response to or otherwise related to the conversation 106).

The sparked conversation 114 may include additional user generated content that is related to the conversation 106 but as a new thread or unit. In a manner similar to the conversation 106 including the related third-party content 108, the sparked conversation 114 may utilize the conversation 106 as the source or background information.

In the illustrated example, the sparked conversation 114 may be made available via the platform 102 to various users in a manner similar to the original conversation 106. Additionally, the platform 102 may notify the user 104 via an alert, notification, indication within the conversation 106, and the like as to the creation of the sparked conversation 114. In this example, the platform 102 may also send or allow the user 104 to access the sparked conversation 114 in response to the user 112 creating the sparked conversation 114.

In addition to making the conversation 106 publicly available, the user 104 may invite additional users, such as user 116, to participate in or add to the conversation 106. In some cases, the platform 102 may notify or alert the user 116 that they have been invited to participate in the conversation 106. The user 116 may accept or decline the invitation. In the situation in which the user 116 accepts the invitation, the user 116 may contribute to the conversation by generating or capturing additional user generated content item. The platform 102 may then organize the user generated content items (such as videos, audio, or a combination thereof) in, for example, chronological order based on a time of posting. In the current example, after adding the additional user generated content, the platform 102 may send the updated conversation 118 to the other contributing users, including the user 104. In other examples, the platform 102 may notify the contributing users, such as user 104, via a notification, alert, or indication within the conversation 106 itself.

Thus, when an additional user, not shown, consumes the conversation 106, the additional user may transition between the user generated content items in order without having to access different users pages, feeds, or the like. Thus, the platform 102 discussed herein improves the conventional network by organizing the user generated content into the conversations, such as conversations 106 and the sparked conversation 114, thereby reducing the number of user accesses and requests required to consume the associated user generated content. In this manner, the platform 102 reduces the network and system resources associated with the platform 102. For example, by reducing the number of access requests to consume the conversation 106, the platform 102 reduces the total bandwidth consumption associated with consuming user generated content in comparison to conventional systems, as users may access multiple related content items via a single user input and at a single location.

In the illustrated example, the platform 102 may be communicatively coupled to various other electric devices, systems and users as shown via one or more networks 120-126 via wired technologies (e.g., wires, USB, fiber optic cable, etc.), wireless technologies (e.g., RF, cellular, satellite, Bluetooth, etc.), or other connection technologies. The networks 120-126 may be any type of communication network, including data and/or voice network (such as the internet), and may be implemented using wired infrastructure (e.g., cable, CATS, fiber optic cable, etc.), a wireless infrastructure (e.g., RF, cellular, microwave, satellite, Bluetooth, etc.), and/or other connection technologies. In general, the networks 120-126 carry data, such as the user generated content of the conversations 106 and 114, between the platform 102, the users 104, 112, and 114, and the third-party systems 110.

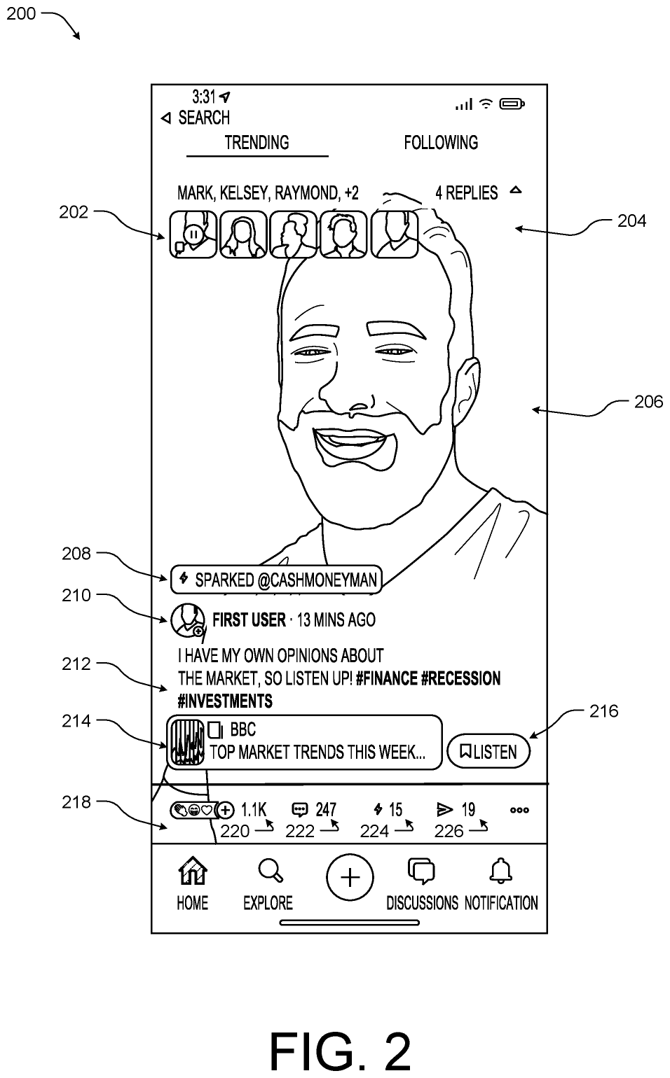

FIG. 2 illustrates an example pictorial view of a user consuming a conversation via the platform of FIG. 1 according to some implementations. For instance, in the illustrated example, a user may be consuming a current user generated content item 202(1). The current user generated content item 202(1) may be indicated within the conversation progress indicator area 204 and displayed or played within the main display area 206.

In the illustrated example, the conversation includes five user generated content items 202(1)-(5). The user generated content items 202(1)-(5) may be arranged in chronological order. Thus, in the current example, the user is currently consuming the first user generated content items 202(1) and following the current user generated content items 202(1), the user may consume three additional content items 202(2)-(4) generated by three other participating users. The final content item 202(5) is an additional content item generated by the initiating user responding to one or more of the other content items 202(2)-(4). In the current example, the conversation includes five content items 202(1)-(5). However, it should be understood that a conversation may include any number of content items.

In this example, the user may transition between the different content items 202(1)-(5) by either selecting the desired content item from the conversation progress indicator area 204 and/or by swiping the display in a first direction (e.g., to the left). Likewise, the user may transition to a preceding content item by selecting the content item from the conversation progress indicator area 204 and/or by swiping the display in a second direction opposite the first direction (e.g., to the right). In this example, the user may also be able to transition to another conversation without leaving the current display 200. For example, the user may swipe the screen in a third direction perpendicular to the first direction and the second direction (e.g., upward) to transition to the next conversation. Likewise, the user may swipe the screen in a fourth direction opposite the third direction and also perpendicular to the first direction and the second direction (e.g., downward) to transition to the prior conversation.

In the illustrated example, in addition to the display area 204 and the conversation progress indicator area 206, the current display 200 includes a sparked reference area 208, an author information area 210, a description area 212, and a background information area 214. The sparked reference area 208 may be associated with a sparked or quoted conversation (e.g., the current conversation may be a conversation triggered from another conversation or user generated content published by another user). In some cases, the user may be transitioned to the originating or sparked conversation and/or the particular user generated content item 202(1) by selecting the sparked reference area 208.

The author information area 210 may include information associated with the author of the currently visible content item 202(1) (e.g., the content item presented in the display area 206) of the conversation. In some cases, the user may follow, like, or otherwise request the platform to provide notification or alerts when the author publishes additional content by selecting the author information area 210. The description area 212 may include a text-based summary or commentary associated with the current content item 202(1). The background information area 214 may include a selectable area that allows the consuming user to transition to an article or background information to assist with the understanding of the content item 202(1). In some cases, the background information may be a single article or source content for the entire conversation, while in other example, the background information area 214 may include individual or differing source content for each content item 202(1)-(5) of the conversation.

In the current example, the display 200 may also include a listen button or icon 216. The listen icon 216 may be selected for the consuming user to opt in or request notification related to the conversation. For example, if a sixth content item, not shown, was added to the conversation and the consuming user had selected the listen icon 216, the consuming user would receive a notification, alert, or other indication that the conversation has new content available.

The current display 200 may also include a status bar area 218 that provides various status indicators and/or options to the consuming user. For example, the status bar 218 may include a like or thumbs up option 220, a comment option 222, a sparked or sparked option 224, and a forward option 226. The like option 220 may both indicate the number of users whom have found the conversation or content item 202(1) enjoyable and allow the consuming user to also indicate they enjoyed the conversation. The comment option 222 may indicate the number of user comments associated with the conversation or content item 202(1) and upon selection allow the consuming user to add a comment and/or view other users comments. The sparked option 224 may indicate a number of sparked conversations resulting or originating from the conversation or content item 202(1) and upon selection allow the consuming user to create or otherwise generate a sparked conversation related to the conversation or the content item 202(1). The forward option 226 may indicate the number of forwards as well as allow the user upon selection to send the conversation or content item 202(1) to additional users of the platform.

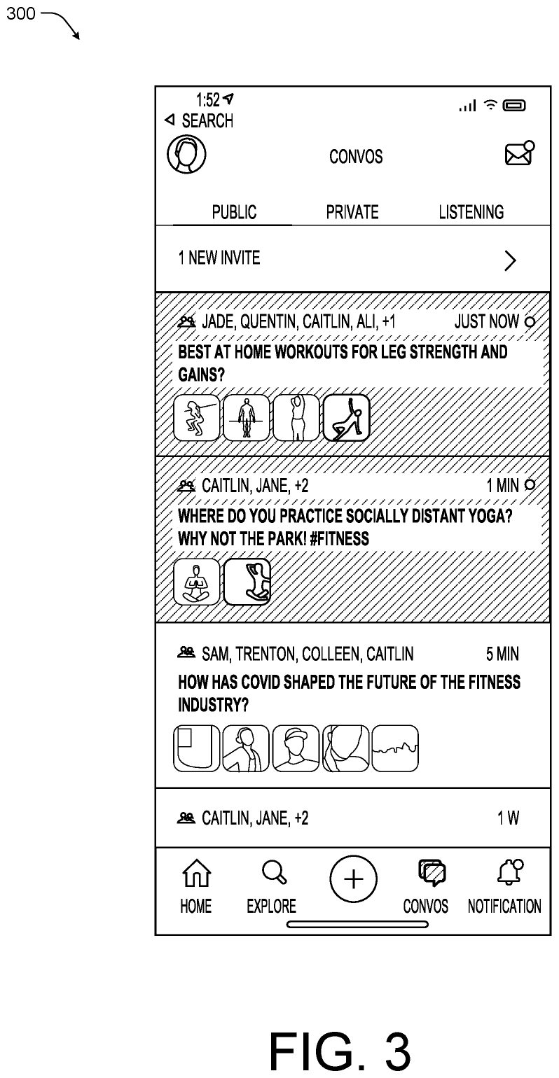

FIG. 3 illustrates an example pictorial view of a user exploring source content for a conversations via the platform of FIG. 1 according to some implementations. In the current display 300, a user may view various articles and/or other curated content (e.g., conversations, news, etc.) that the user may utilize as a background information and/or a source content for a user generated content item and, thereby, a conversation. For instance, in the current example, the user is exploring news feed that may be curated for the user based on the user's likes and interests by the platform 102. In other cases, the user may explore conversations and/or content by topics.

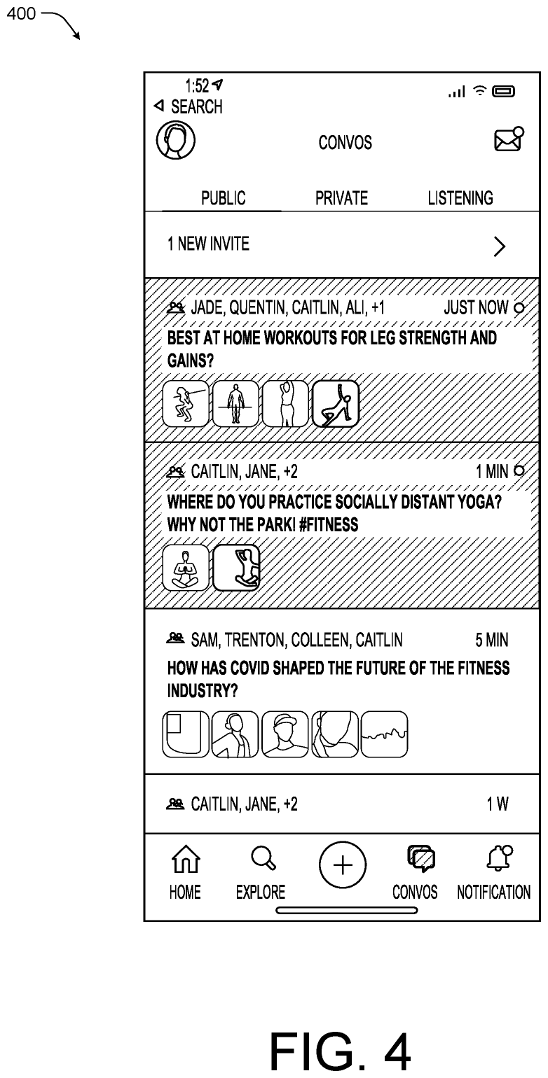

FIG. 4 illustrates an example pictorial view of a user viewing an active conversation list via the platform of FIG. 1 according to some implementations. In the illustrated example, the current display 400 may include a list of public conversations (e.g., open to any user), private conversations (e.g., invite only or authorized user only conversations), and listening conversations (e.g., conversations that the current user is consuming but not participating in). In this example, the user is viewing a list of public conversations. For example, the user has been invited to the participate in one new conversation and has at least three other conversations that are active within the last week. In this example, the display 400 may also indicate the participating users, the topic or heading of the conversation, and a time associated with the publishing of the latest content item for each conversation on the list.

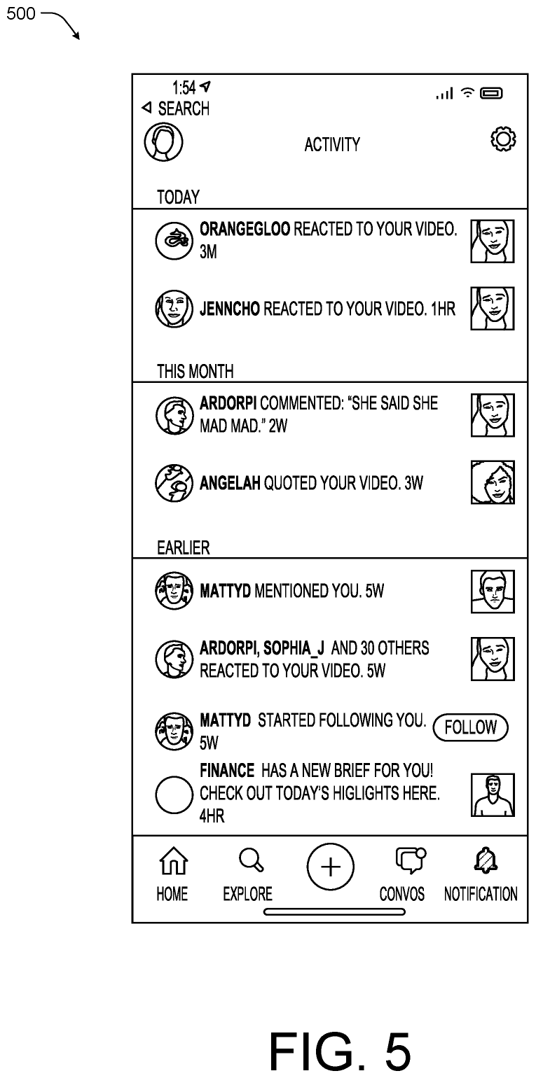

FIG. 5 illustrates an example pictorial view of a user viewing current activity associated with the user's conversation via the platform of FIG. 1 according to some implementations. In the current display 500, the user may be viewing recent and/or current activity associated with the user's conversations. For example, in the current example, the user may have received two reactions to the user's published content items.

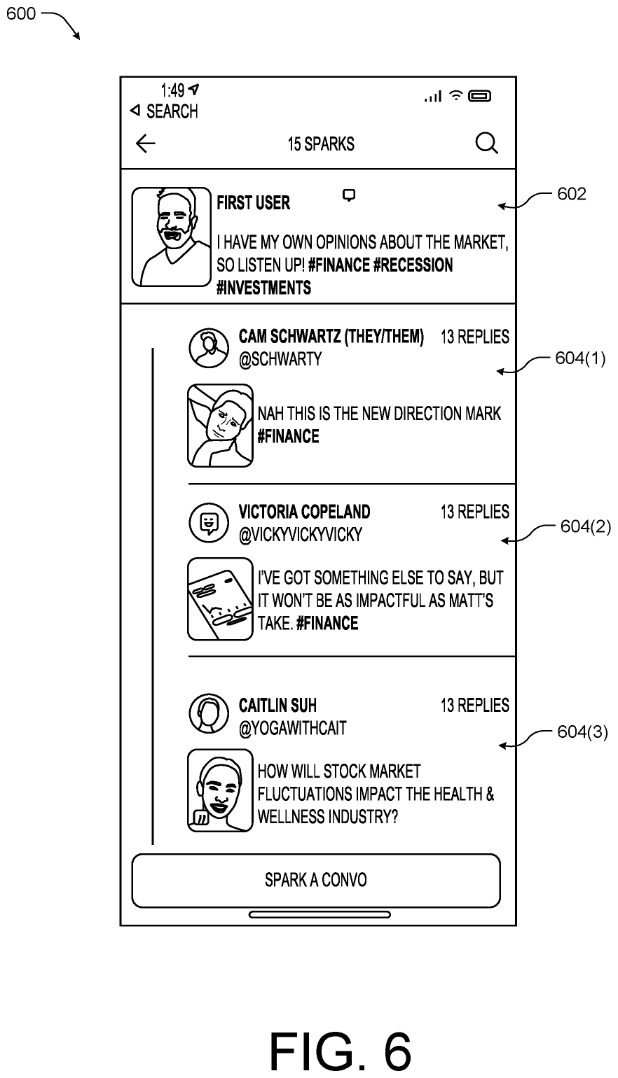

FIG. 6 illustrates an example pictorial view of a user viewing a list of conversation sparked from the user's own or participating conversations via the platform of FIG. 1 according to some implementations. In the current display 600, the user may view the text-based description, summary, or commentary associated with each conversation that has been sparked by the user's content. For example, the user's conversation 602 related to the market has generated three sparked conversations 604(1)-(3).

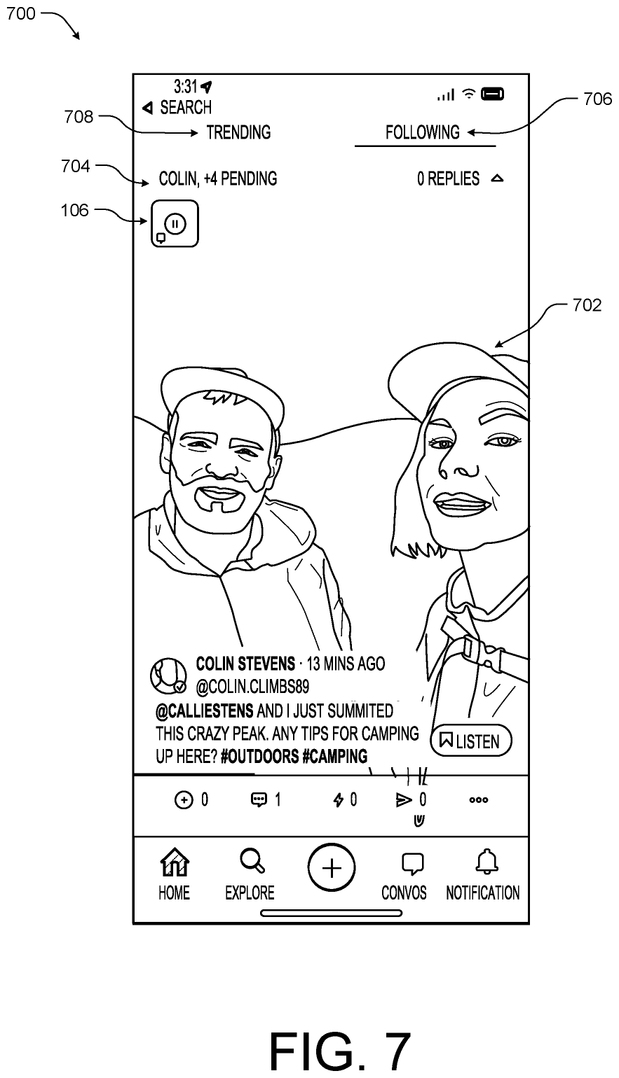

FIG. 7 illustrates an example pictorial view of an initiating user generated content item for a conversations associated with the platform of FIG. 1 according to some implementations. In the display 700, a user is generating a first content item 702 for a conversation. As such, the content item 702 is the only content item within the progress indicator area 106. Additionally, the user has also invited additional users to participate in the conversation. The additional users are currently listed as pending within the participating user area 704 above the progress indicator area 106. In some cases, once a user accepts the invitation and/or participates in the conversation, the user's name, identifier, or other indictor will be added to the participating user area 704.

In the current example, the user is also currently viewing only conversations the user has selected to follow or listen. This status is indicated by the selection of the following icon 706. In this state, when the user swipes the screen up or down, as discussed above, the user will progress forward or backward through the conversations the user is listening too. Alternatively, the user may select, for instance, the trending icon 708. In the trending state, the user may progress forward and backward through trending conversations, again by swiping the display 700 upward or downward. In various other examples, the user may place the display 700 in other states, such as topic based, sparked, related, and the like. In each additional state, the user may again progress forward or backward via swiping the display upwards and/or downwards.

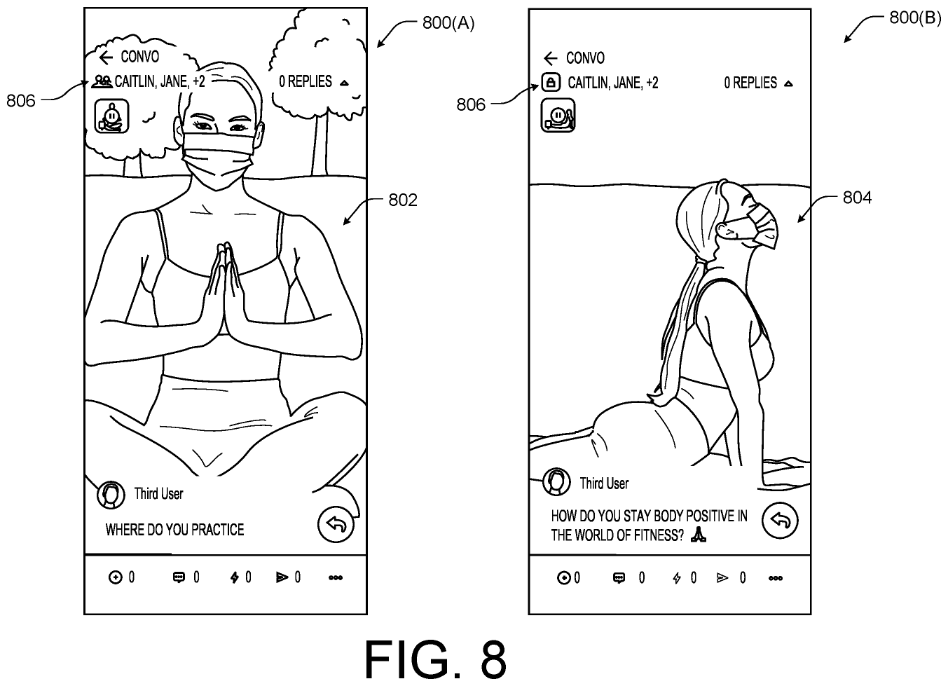

FIG. 8 illustrates an example pictorial view of a user viewing their user generated content of two different conversations associated with the platform of FIG. 1 according to some implementations. In the current example, the user is first viewing a first display 800(A) showing a first user generated content item 802 of a first conversation and the second display 800(B) showing a second user generated content item 804 of a second conversation. Similar, to transition between public conversations of other users, the user may transition between the user's conversations by for instance swiping the display to the right or left. In this example, the user may swipe the display horizontally to transition between the first conversation of display 800(A) and the second conversation 800(B) as they relate to fitness. In some cases, the user may also swipe the display upward and downward to transition to the user's conversations associated with other topics, such as finance, math, politics, as a few examples.

In display 800(A), the conversation is open for the public to respond as indicated by group icon 806. In some cases, in the public conversation of display 800(A) any user may add user generated content items to the conversation and any user may invite other participants to the conversation. In another case, the public conversation may be invite only, but any participant may be given the rights to invite other participants. Alternatively, the conversation may be made private by a selection of the group icon 806. Upon a selection, the group icon 806 may transition to a lock icon 808 shown in display 800(B). In a locked or private conversation, only the user's and the user's invited participants may add user generated content items to the conversations.

In some cases, particularly when the conversation is open to public (e.g., the general user base of the platform), the platform may monitor the content being added to conversations and posted with the platform. For example, as the user records the user generated content item 802, the platform may perform speech to text analysis on the audio content of the content item 802. The platform may then parse the resulting text to identify words that are marked or identified as banned, inappropriate, offensive, and the like. In response to detecting a banned word, the platform may remove or otherwise obscure the word such that a consumer of the content item is unable to hear the banned word. In other cases, the platform may remove a portion of the content item (e.g., the video and audio) from the content item that corresponds to the banned word prior to publication. In yet another case, the platform may prevent the content item from being published or otherwise added to the conversation. In this case, the platform may also notify the user that recorded the content item and alert them to the status of the word. If the user is a repeat offender the platform may revoke the user's rights to access and/or publish to the platform.

In a similar manner, the platform may also be configured to identify inappropriate or banned visual content within the user generated content items. For example, the platform may parse the content into a series of still images. The platform and/or a third-party system may then parse or analyze the still images to identify banned content, such as a nudity, weapons, offensive gestures, and the like. Again, the platform may then remove the banned content from the content item prior to publication. In some cases, the platform may also notify the user that recorded the content item and alert them to the status of the offensive content. In one example, the user may be able to provide a justification for the offensive content in which case the platform may allow the publication of the entire user generated content item. In one implementation, the platform may present the user with a choice between not publishing the content item and providing a justification. If the user provides an erroneous justification the platform may restrict the user's future access to and/or ability to publish on the platform. Additionally, if the user is repeatedly recording banned content, the platform may revoke the user's rights to access and/or publish to the platform.

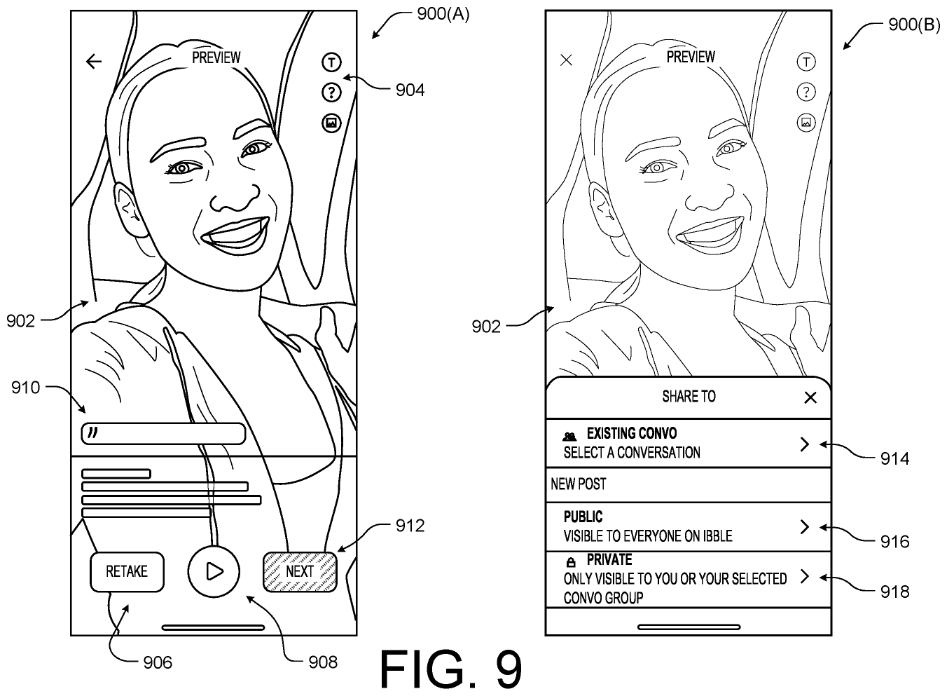

FIG. 9 illustrates an example pictorial view of a user recording user generated content 902 of a conversation associated with the platform of FIG. 1 according to some implementations. In the current example, as shown in display 900(A), the user may first record the user generated content using an electronic device, such as a smart phone, tablet, and the like. The user may then view the recorded content in a preview mode prior to publishing to the platform. In the preview mode the user may edit the content item using various tools by selection of the editing tools, generally indicated by 904. For instance, the user may add text overlays via a text overlay icon, insert a question via the question icon, add thumbnails or other graphics using the graphic icon, and the like.

The user may also retake or start over with the recording by selecting the retake icon 906 and/or view, pause, or otherwise consume the content item via the play icon 908. The user may also be able to insert user information, background information, comments, and the like via the visual overlay guides, generally indicated by 910. Once the user is finished editing the content item 902, the user may select the next icon 912 to transition to display 900(B) and the share or post interface.

The display 900(B) may still be in a preview mode but allow the user to add the user generated content item 902 to an existing conversation via area 914, create a new conversation open to the public via area 916, and/or create a new private conversation via area 918. When adding the content item 902 to an existing conversation and upon selection of area 914, the user may be presented with a list of active conversations ranked based on most recent overall activity, most recent user activity, most commonly used conversation within a time window (e.g., within 1 day, 1 week, 1 month, etc.), most consumed conversation, most liked conversation, as well as many other metrics.

When creating a new conversation, the user may be prompted to select or invite participants from a list, add one or more tags associated with the topic of the conversation to assist other users in identifying and searching for the conversation, and the like. In some cases, the platform may prompt the user to complete any additional information such as identifying a source or background document, adding a comment, and the like. Finally, either with new or existing conversations, the user may be prompted to either save the content item 902 as a draft or publish.

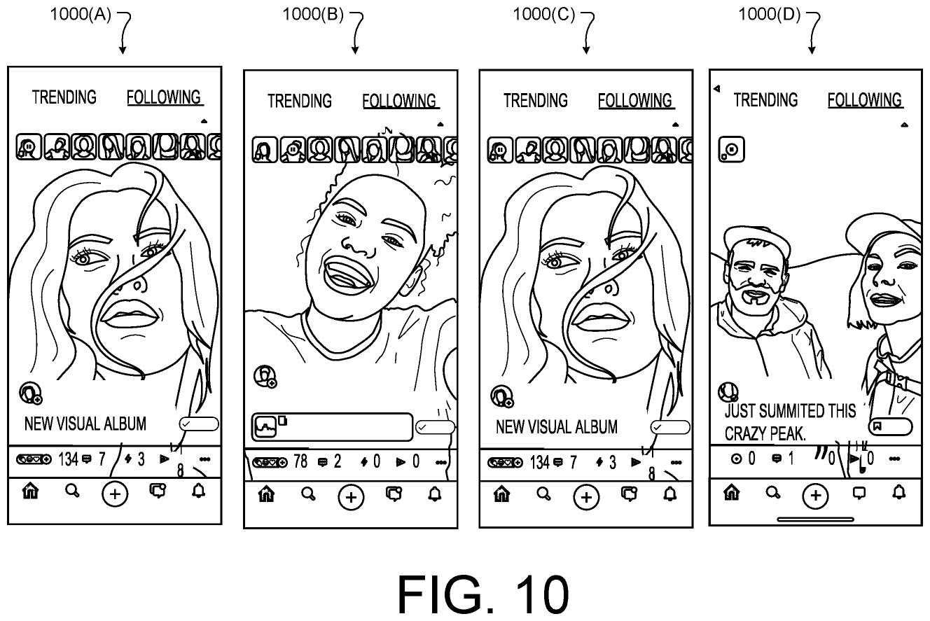

FIG. 10 illustrates an example pictorial view of a user transitioning between content items and conversations of the platform of FIG. 1 according to some implementations. In the current example, the user is initially, at display 1000(A), viewing a first content item of a first conversation. In this example, the user may desire to transition to a second content item of the first conversation. Thus, the user may swipe the display 1000(A) to the left and cause the display 1000(B) to be presented. The user may then consume the second user generated content item associated with the first conversation. At some point, the user may desire to return to the prior or the first user generated content item. The user may then swipe the display 1000(B) to the right and transition to display 1000(C) which also displays the first user generated content item. At some time, the user may desire to move to a new conversations. At this time, the user may swipe the display 1000(C) upward or downward to transition to the next or previous conversations and the second conversation may be presented as display 1000(D).

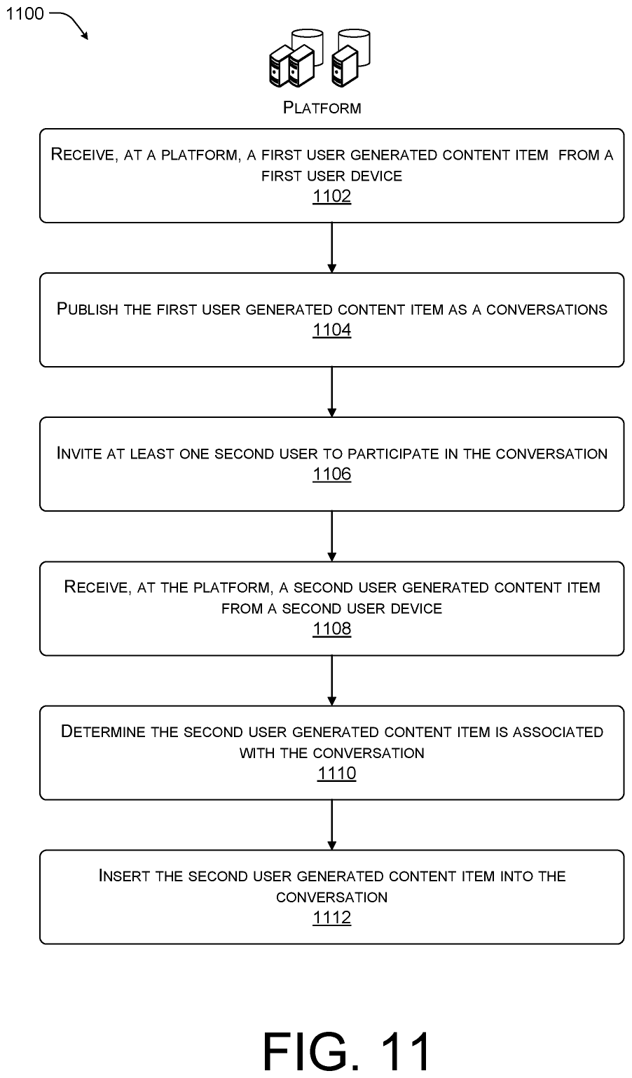

FIGS. 11-14 are flow diagrams illustrating example processes associated with the platform 102 of FIG. 1 and the displays of FIGS. 2-10 according to some implementations. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 11 illustrates an example flow diagram showing an illustrative process 1100 for organizing a conversation according to some implementations. As discussed above, a platform may be configured to organize user generated content items or content items into conversations to reduce the overall computing resource or network resources expended by users with respect to accessing and consuming content via the platform.

At 1102, the platform may receive a first user generated content item of from a first user device. The first user device may be associated with a first user or first user account of the platform. The first user generated content item may be a short video including visual and/or audio data that the first user captured via the first user device. The first user generated content item may also include an indication of invited participants, user text-based commentary, and/or an identification of a source document, as discussed above.

At 1104, the platform may publish the first user generated content item as a conversation. For example, the platform may determine the first user generated content item is currently not associated with or part of an existing conversation. The platform may make this determination based at least in part on a selection by the user, a process by which the first user generated content item was created or captured, and/or by analyzing the first user generated content items and comparing with existing conversations.

At 1106, the platform may invite at least one second user to participate in the conversation. For example, the first user generated content item may include an indication that the first user desires the second user to participate in the conversation. In response, the platform may send an alert to an account or second user device associated with the second user notifying the second user that the conversation exists and that the second user has been invited by the first user to participate. In some cases, the platform may also send the first user generated content item to the second user device or the second user's account. In in this example, the user may have invited a second user but it should be understood, that the first user may have invited a plurality of users to participate and the platform may notify or alert each user that was invited as to the existence of the conversation and the desire of the first user for the other users to participate.

At 1108, the platform may receive a second user generated content item of from a second user device associated with the second user. The second user generated content item may be a second short video including visual and/or audio data that the second user captured via the second user device and related to the first user generated content item. The second user generated content item may also include additional indications of additional invited participants, additional user text-based commentary, and/or an identification of a second source document.

At 1110, the platform may determine the second user generated content item is associated with the conversation. For example, the second user may provide a selection to associate the second user generated content item with the conversation and/or initiated the recording by selecting the alert or notification associated with the conversation and provided by the platform.

At 1112, the platform may insert the second user generated content item into the conversation. For example, the platform may postpend the second user generated content item to the conversation as the last or most recently added content item. In other cases, the platform may insert the second user generated content item based at least in part on a time stamp associated with the creation of the content item or based at least in part on the user generated content item of the conversation to which the second user generated content item is responsive. In this manner, the platform may attempt to maintain an order and/or structure to the conversations that assist a consuming user in understanding and following the conversation.

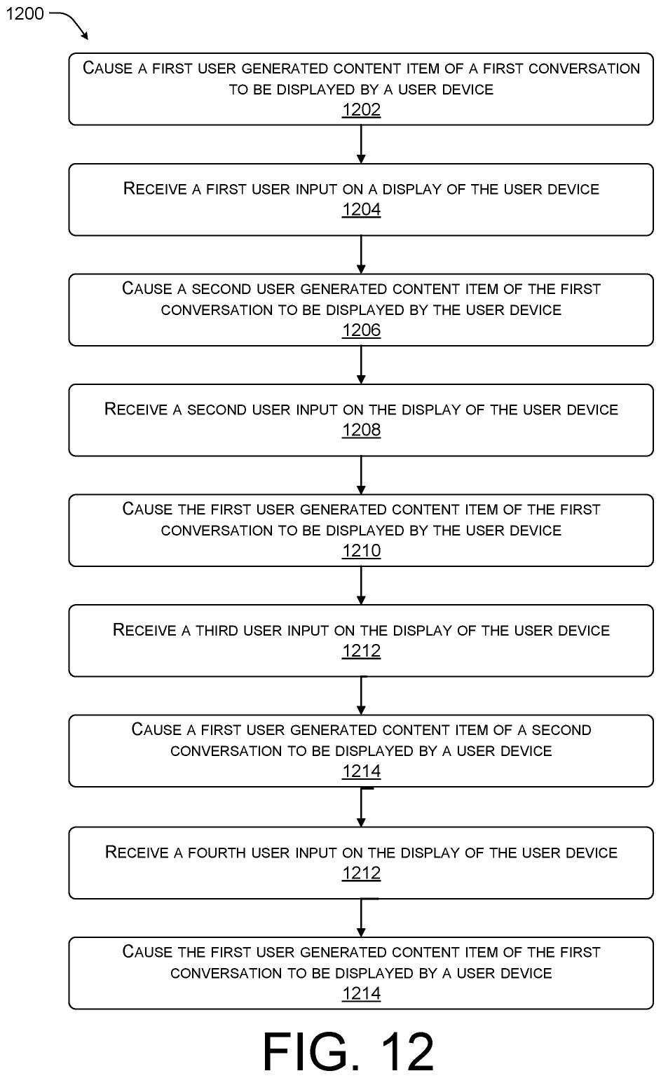

FIG. 12 illustrates an example flow diagram showing an illustrative process 1200 for navigating between user generated content items and conversations according to some implementations. As discussed above, when a user is consuming content, the user may quickly transition between different content items of a conversation and between conversations without navigating through a plurality of menus and/or displays.

At 1202, the platform and/or an application hosted on a user device may cause a first user generated content item of a first conversation to be displayed by the user device. For example, the user device may display the most recently viewed conversation by the user, a conversation that is currently popular or the most popular, a conversation determined to be of interest to the user, and the like.

At 1204, the platform and/or the application hosted on the user device may receive a first user input on the display of the user device. For example, the user may swipe the display to the left or select the right-hand side of the display. In some cases, the display may be partitioned into areas such as a top, bottom, left, and right portion. In this case, the user may have selected the right-hand portion and/or touched the display and pulled the display to the left (e.g., from the right to the left).

At 1206, the platform and/or the application hosted on the user device may cause a second user generated content item of the first conversation to be displayed by the user device. In this example, the second user generated content item may be a subsequent user generated content item or the next user generated content item of the conversation. In some cases, the second user generated content item may share the text-based information of the first user generated content item and/or the source information or document. In other examples, the second user generated content item may include different text-based information and/or source information or document.

At 1208, the platform and/or an application hosted on the user device may receive a second user input on the display of the user device. For example, the user may swipe the display to the right or select the left-hand side of the display. For example, in this case, the user may have selected the left-hand portion and/or touched the display and pulled the display to the right (e.g., from the left to the right).

At 1210, the platform and/or the application hosted on the user device may cause the first user generated content item of the first conversation to be displayed by the user device. In this example, the user may have decided to return or re-watch or consume the first user generated content item. For instance, the user may have been consuming the second user generated content item and realized they may have missed a point or information of the first user generated content item. The user may then return to the first user generated content item by swiping the display to the left.

At 1212, the platform and/or the application hosted on the user device may receive a third user input on the display of the user device. For example, the user may swipe the display to upward or select the top portion of the display. For example, in this case, the user may have selected the bottom portion and/or touched the display and pulled the display to the upward (e.g., from the bottom to the top).

At 1214, the platform and/or the application hosted on the user device may cause a first user generated content item of a second conversation to be displayed by the user device. In this example, the user may have decided to transition to a new conversation. The second conversation may be related to the first conversation based on participants, topic, source information or document, and the like. In other cases, the second conversation may be selected by the platform based on popularity, views, data known about the consuming user (e.g., interests, likes, dislikes, geographic location, current weather, platform interactions and/or participation), and the like.

At 1216, the platform and/or the application hosted on the user device may receive a fourth user input on the display of the user device. For example, the user may swipe the display to downward or select the bottom portion of the display. For example, in this case, the user may have selected the top portion and/or touched the display and pulled the display to the downward (e.g., from the top to the bottom).

At 1218, the platform and/or the application hosted on the user device may cause the first user generated content item of the first conversation to be displayed by the user device. In this example, the user may have decided to transition to back to the previous conversation, for instance, to consume the next or third user generated content item associated therewith.

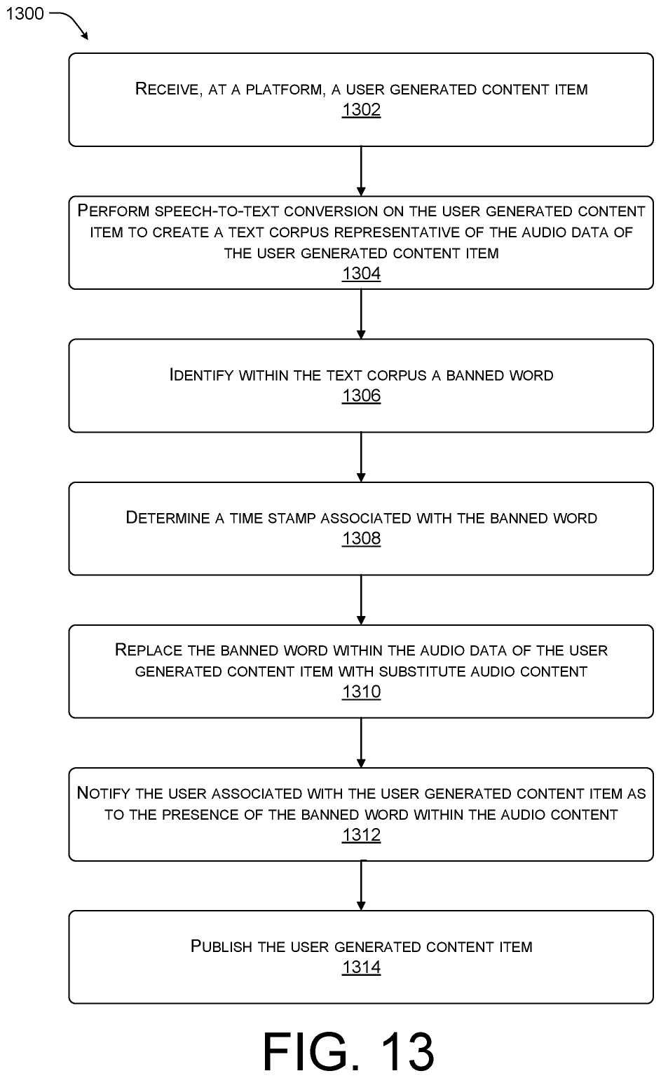

FIG. 13 illustrates an example flow diagram showing an illustrative process 1300 for monitoring audio content of a user generated content item according to some implementations. In some cases, content associated with one or more conversation may be unacceptable for one or more of the consuming users of the platform. In some cases, particular types of content may be banned for a particular type or class of user (e.g., children), while in other cases particular content may be banned for all users. In these cases, the platform may still publish user generated content items, but having removed the banned content prior to publication.

At 1302, the platform may receive a user generated content item. For example, the user device may be associated with a user or first user account of the platform. The user generated content item may be a short video including visual and/or audio data that the first user captured via the first user device. The user generated content item may also include an indication of invited participants, user text-based commentary, and/or an identification of a source document, as discussed above.

At 1304, the platform may preform speech-to-text conversation on the user generated content item to create a text corpus representative of the audio data of the user generated content item. For example, the platform may process the audio data to detect each spoken word and convert the spoken word into a textual representation.

At 1306, the platform may identify within the text corpus a banned word. For example, the banned word may be flagged by the platform, by the user, or another participant (such as the user initiating the conversation), and the like. In some cases, the banned words may include words that are deemed offensive, derogatory, or otherwise inappropriate.

At 1308, the platform may determine a time stamp associated with the banned word. For example, the time stamp may correspond to a time within the recording of the content in which the banned word is spoken and/or detected.

At 1310, the platform may replace the banned word within the audio data of the user generated content item with substitute audio content. For example, the platform may remove the audio data from the user generated content item corresponding to a window of time about the time stamp. In other cases, the platform may insert additional audio content over the audio data of the user generated content item corresponding to the window of time about the time stamp.

At 1312, the platform may notify the user associated with the user generated content item (e.g., the author) as to the presence of the banned word within the audio content. In some cases, the notification may inform the user that the banned word has been removed. In other cases, the notification may indicate suspension of rights within the platform for use of the banned word and violation of a platform related agreement.

At 1314, the platform may publish the user generated content item. For instance, once the banned word is removed from the audio content, the platform may proceed to publish the user generated content item. In some cases, the original version of the user generated content item may be published to first segment of users (such as adults or opt in users) and the edited version of the user generated content to a second segment of users (such as children).

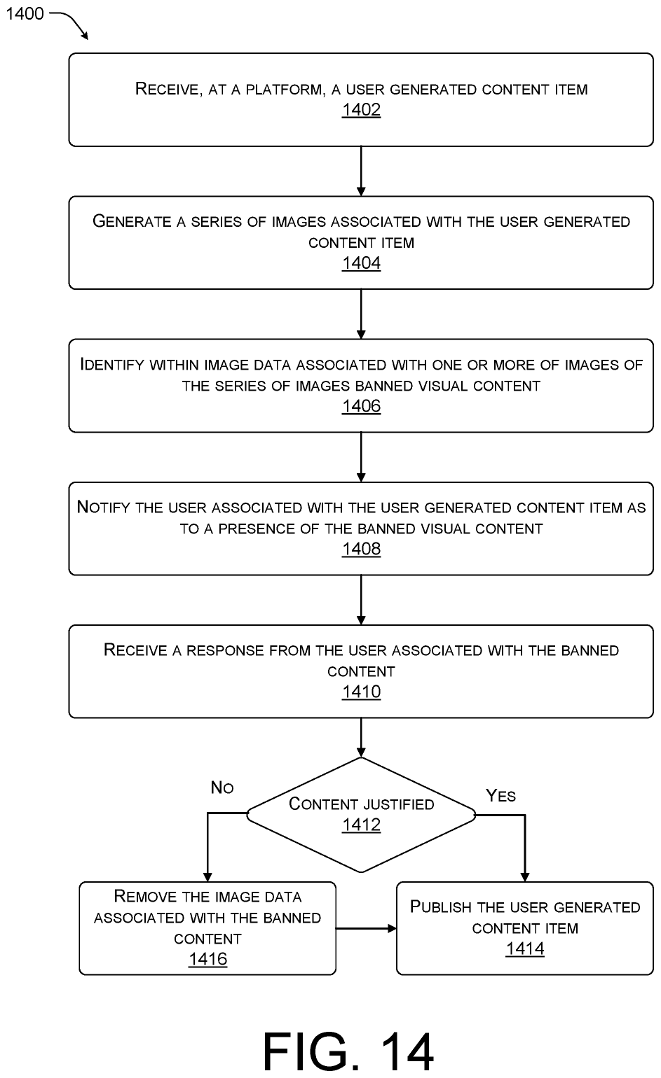

FIG. 14 illustrates an example flow diagram showing an illustrative process 1400 for monitoring visual content of a user generated content item according to some implementations. In some cases, content associated with one or more conversations may be unacceptable for one or more of the consuming users of the platform. In some cases, particular types of content may be banned for a particular type or class of user (e.g., children), while in other cases particular content may be banned for all users. In these cases, the platform may still publish user generated content items but having removed the banned content prior to publication.

At 1402, the platform may receive a user generated content item. For example, the user device may be associated with a user or first user account of the platform. The user generated content item may be a short video including visual and/or audio data that the first user captured via the first user device. The user generated content item may also include an indication of invited participants, user text-based commentary, and/or an identification of a source document, as discussed above.

At 1404, the platform may generate a series of images (e.g., frames) associated with the user generated content item. For example, the platform may generate a predetermined number of images per second from the user generated content item.

At 1406, the platform or a third-party system may identify within image data associated with the one or more images of the series of images banned visual content. For example, the platform may ban X-rated content, violent content, plagiarized content, and the like.

At 1408, the platform may notify the user associated with the user generated content item (e.g., the author) as to the presence of the banned content within the visual content. In some cases, the notification may inform the user that the banned content has been removed. In other cases, the notification may indicate suspension of rights within the platform for presence of the banned content and violation of a platform related agreement. In one implementation, the notification may alert the user as to an appeal or justification process in which the user may request re-instatement of the removed visual contentment.

At 1410, the platform may receive a response from the user associated with the banned content and, at 1412, the platform may determine if the content is justified based at least in part on the response. For example, the user may have included content the platform identified as plagiarized or theft. However, the user may have been acting within their freedom of speech rights to criticize or parody a copyright work. In this case, the use of the banned content may be justified and the process 1400 may proceed to 1414 and publish the original version of the user generated content item. However, if the platform determines the content is not justified, the process 1400 may advance to 1416.

At 1416, the platform may remove the image data associated with the banned content. For example, the platform may remove the image of the series of images including the banned content. In some cases, the platform may remove multiple images of the series of images. The process 1400 may then move to 1414 and publish the edited version of the user generated content item. Alternatively, the platform may prevent the user generated content item from publishing at all.

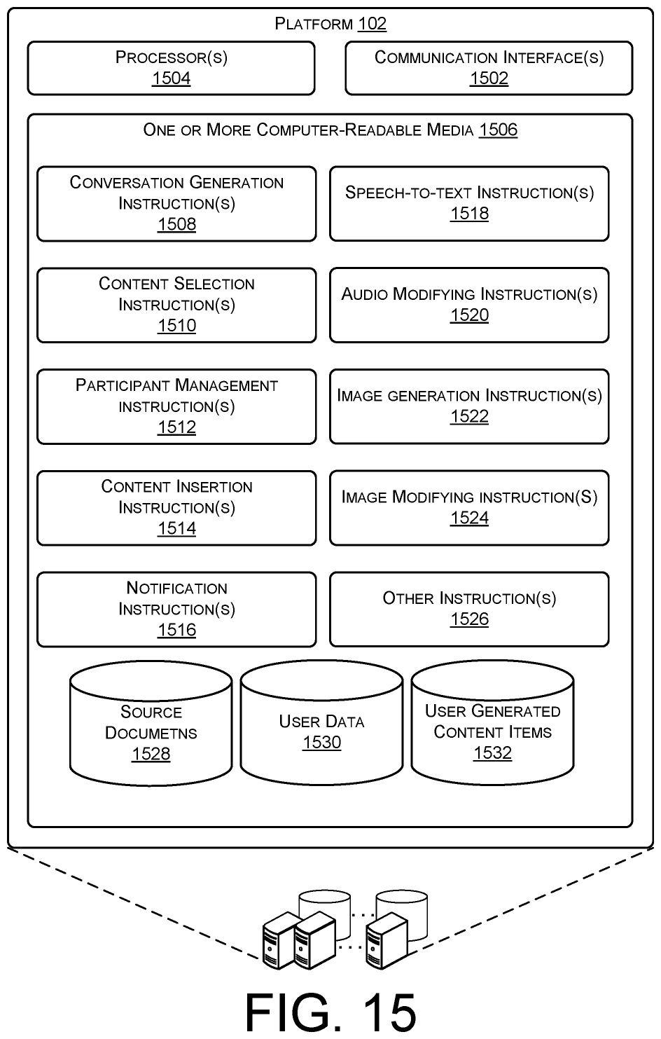

FIG. 15 illustrates an example platform 102 for organizing user generated content items according to some implementations. In the illustrated example, the platform may be the platform 102 of FIG. 1 and may include one or more communication interfaces 1502 configured to facilitate communication between one or more networks, one or more system (e.g., user devices, third-party systems, validation systems, etc.). The communication interfaces 1502 may also facilitate communication between one or more wireless access points, a master device, and/or one or more other computing devices as part of an ad-hoc or home network system. The communication interfaces 1502 may support both wired and wireless connection to various networks, such as cellular networks, radio, WiFi networks, short-range or near-field networks (e.g., Bluetooth®), infrared signals, local area networks, wide area networks, the Internet, and so forth.

The platform 102 includes one or more processors 1504, such as at least one or more access components, control logic circuits, central processing units, or processors, as well as one or more computer-readable media 1506 to perform the function of the platform 102. Additionally, each of the processors 1504 may itself comprise one or more processors or processing cores.

Depending on the configuration, the computer-readable media 1506 may be an example of tangible non-transitory computer storage media and may include volatile and nonvolatile memory and/or removable and non-removable media implemented in any type of technology for storage of information such as computer-readable instructions or modules, data structures, program modules or other data. Such computer-readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 1504.

Several modules such as instructions, data stores, and so forth may be stored within the computer-readable media 1506 and configured to execute on the processors 1504. For example, as illustrated, the computer-readable media 1506 stores conversation generation instructions 1508, content selection instructions 1510, participant management instructions 1512, content insertion instructions 1514, notification instructions 1516, speech-to-text instructions 1518, audio modifying instructions 1520, image generation instructions 1522, image modifying instructions 1524, as well as other instructions 1526, such as an operating system. The computer-readable media 1506 may also be configured to store data, such as source documents 1528, user data 1530, and user generated content items 1532.

The conversation generation instructions 1508 may be configured to process incoming user generated content items. For example, the conversation generation instructions may be configured to initiate or publish new conversations when a particular user generated content item is unassociated with an existing conversation. In some implementations, the conversation generation instructions 1508 may be configured to determine if the user generated content item is associated with an existing conversation or not based on the data associated with the user generated content item. For example, the data associated with the user generated content item may include a flag or other indication that the user generated content item is to be associated with a new conversation.

The content selection instructions 1510 may be configured to select the next conversation for a user consuming content via the platform 102. For example, the content selection instructions 1510 may select the next conversation for the user when the user, for instance, swipes the display downward or touches the top portion of the display. In some cases, the content selection instructions 1510 may select the content based at least in part on a state of the application on the user's device (e.g., trending, following, and the like). In other cases, the content selection instructions 1510 may select the content based at least in part on the user data 1530 (e.g., consuming history, preferences, demographic information, physical location, and the like) or other information known about the user. In still other cases, the content selection instructions 1510 may select the content based at least in part on a state or status of various conversations (e.g., popularity, number of views, number of likes, number of simultaneous/overlapping views or currently views, number of sparked conversations, number of comments, and the like). In some instance, the content selection instructions 1510 may select the content based at least in part on a combination of the above referenced data as well as additional data.

The participant management instructions 1512 may be configured to invite or notify invited users that the users have been requested to participate in a particular conversation. In some cases, the participant management instructions 1512 may also restrict users from participating in conversations, such as when the user's posts contain banned content, or the initiating user has placed a user on a black or unauthorized list.

The content insertion instructions 1514 may be configured to insert and arrange or order the content items of a particular conversation. For instance, the content insertion instructions 1514 may order the content items 1532 based on a time associated with the creation of each content item 1532. In other cases, the content insertion instructions 1514 may arrange the content items 1532 based on the conversation to which a current content item is responsive and the time of recording. For instance, in one particular example, if a fourth content item is responsive to the first content item and the conversation already includes a second content item responsive to the first content item and a third content item responsive to the second content item, the content insertion instructions 1514 may insert the fourth content item after the second content item but prior to the third content item as the fourth content item was recorded after the second content item but is responsive to the first content item.

The notification instructions 1516 may be configured to notify users when a conversation has new content, comments, a new sparked conversation, and the like. For instance, if a user is following or participating in a particular conversation, the notification instructions 1516 may send a notification to a user device, application hosted by a user device, or an account associated with the user to alert them to the new content.

The speech-to-text instructions 1518 may be configured to convert audio content associated with the user generated content items 1532 into a text-based corpus that may be used to identify banned words without the audio transcript of the user generated content items 1532.

The audio modifying instructions 1520 may be configured to analyze or otherwise parse the text-based corpus of the user generated content items 1532 to identify the presence of banned words or sentences within the content. In some case, the audio modifying instructions 1530 may be configured to identify a time stamp associated with the banned word or words and to replace the audio content within the user generated content items 1532 corresponding to the time stamp (or within a window of time assorted with the time stamp) prior to publication by the platform 102.

The image generation instructions 1522 may be configured to generate a series of still images or frames per second from the user generated content items 1532. In some cases, the number or frequency of the frames may be predetermined or set by an operator of the platform 102.

The image modifying instructions 1524 may be configured parse or analyze the frames generated by the image generation instructions 1522 and to remove frames from the user generated content items 1532 when banned content is identified. In some cases, the image modifying instructions 1524 may be configured to remove a number of frames about a frame containing the banned content. For example, the image modifying instructions 1524 may remove 2, 5, 10, etc. frames to either side of the frame containing the banned content. In some cases, the image modifying instructions 1524 may notify the user as to the existence of the banned content.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A system comprising:
one or more communication interfaces;
one or more processors; and
computer-readable storage media storing computer-executable instructions, which when executed by the one or more processors cause the one or more processors to:
present a first user generated content item on a display, the first user generated content item associated with a first conversation;
in response to receiving a first user input associated with the display, present a second user generated content item on the display, the second user generated content item associated with the first conversation and subsequent to the first user generated content item;
in response to receiving a second user input associated with the display, present the first user generated content item on the display;
in response to receiving a third user input associated with the display, present a third user generated content item on the display, the third user generated content item associated with a second conversation; and
in response to receiving a fourth user input associated with the display, present the first user generated content item on the display.

2. The system as recited in claim 1, wherein:
the first user input is a first swipe from a first point to a second point across the display, the first point right of the second point;
the second user input is a second swipe from a third point to a fourth point across the display, the third point left of the second point;
the third user input is a third swipe from a fifth point to a sixth point across the display, the fifth point above the sixth point; and
the fourth user input is a fourth swipe from a seventh point to an eighth point across the display, the seventh point below the eighth point.

3. The system as recited in claim 1, wherein the first user generated content item is associated with a first user and the second user generated content item is associated with a second user.

4. The system as recited in claim 1, wherein the computer-readable storage media stores additional computer-executable instructions, which when executed by the one or more processors cause the one or more processors to:
present on the display, in conjunction with the first user generated content item, a first region including an indication of source content associated with the first user generated content item, the first region selectable to transition the display to the source content.

5. The system as recited in claim 4, wherein the computer-readable storage media stores additional computer-executable instructions, which when executed by the one or more processors cause the one or more processors to:
present on the display, in conjunction with the first user generated content item, a second region including text-based description of the first user generated content item.

6. The system as recited in claim 5, wherein the computer-readable storage media stores additional computer-executable instructions, which when executed by the one or more processors cause the one or more processors to:
present on the display, in conjunction with the first user generated content item, a third region including data associated with the first user.

7. The system as recited in claim 6, wherein the computer-readable storage media stores additional computer-executable instructions, which when executed by the one or more processors cause the one or more processors to:
present on the display, in conjunction with the first user generated content item, a fourth region including an indication of a third conversation; and
in response to receiving a fifth user input, presenting a fourth user generated content item associated with a third conversation on the display, the fifth associated with the fourth region.

8. The system as recited in claim 6, wherein the computer-readable storage media stores additional computer-executable instructions, which when executed by the one or more processors cause the one or more processors to:
present on the display, in conjunction with the first user generated content item, a fourth region including a plurality of user selectable icons, at least a first icon of the plurality of user selectable icons associated with the first user generated content item and a second icon of the plurality of the user selectable icons associated with the second user generated content item, the first icon left of the second icon.

9. The system as recited in claim 6, wherein the computer-readable storage media stores additional computer-executable instructions, which when executed by the one or more processors cause the one or more processors to:
present on the display, in conjunction with the first user generated content item, a fourth region including a selectable icon; and
in response to receiving a fifth user input, presenting on the display an interface to capture a new user generated content item, the fifth associated with the fourth region.

10. The system as recited in claim 1, wherein the system is at least one of a client device of a server device.

11. A method comprising:
receiving a user generated content item associated with a social networking platform from a user device, the user generated content item including visual data and audio data;
converting the audio data into a text corpus;
identifying within the text corpus a banned word;
determining a time stamp associated with the banned word, the time stamp relative to the user generated content item;
modifying the audio data within a window of time associated with the time stamp to generate a modified user generated content item; and
publishing the modified user generated content item.

12. The method as recited in claim 11, further comprising sending a notification to a user associated with the user device in response to modifying the audio data.

13. The method as recited in claim 11, further comprising restricting the user access to the social networking platform in response to identifying the banned word.

14. The method as recited in claim 13, wherein restricting the user access to the social networking platform in response to identifying banned word causes the user to meet or exceed a banned word threshold.

15. The method as recited in claim 11, wherein modifying the audio data within the window of time associated with the time stamp further comprises replacing the banned word with substitute audio content.

16. The method as recited in claim 11, wherein modifying the audio data within the window of time associated with the time stamp further comprises removing the audio data within the window of time from the user generated content item.

17. The method as recited in claim 11, further comprising:
determining that the user generated content item is open to a public audience; and
wherein converting the audio data into a text corpus is responsive to the user generated content item being open to the public.

18. A method comprising:
receiving a first user generated content item from a first user device
associating the first user generated content item with a conversation;
identifying a second user that has been invited to participate in the conversation;
sending a notification to a second user device associated with the second user;
receiving a second user generated content item from the second user device;
associating the second user generated content item with the conversation; and
causing a third user device to display an indication of the second user generated content item as related to the first user generated content item, in response to a third user of the third user device consuming the first user generated content item.

19. The method as recited in claim 18, further comprising:
identifying a fourth user that has been invited to participate in the conversation;
sending a second notification to a fourth user device associated with the fourth user;
receiving a third user generated content item from the fourth user device;
associating the third user generated content item with the conversation; and
causing a third user device to display a second indication of the third user generated content item as related to the first user generated content item and the second user generated content item, in response to the third user of the third user device consuming the first user generated content item.

20. The method as recited in claim 18, wherein causing the third user device to display an indication of the second user generated content item as related to the first user generated content item includes displaying an identifier for the first user and the second user, the identifier indicating that the first user and the second user are participating in the conversation.
